(19) United States
(12) Patent Application Publication
(10) Pub. No.: US 2017/0279760 A1
(43) Pub. Date: Sep. 28, 2017

(54) Service Defined Network for Hybrid Unified Communications

(71) Applicant: ShoreTel, Inc., Sunnyvale, CA (US)

(72) Inventors: Bingjun Li, San Jose, CA (US); Pankaj Malhotra, Sunnyvale, CA (US); Deepak M. Bhimasena, Bengaluru (IN)

(73) Assignee: ShoreTel, Inc., Sunnyvale, CA (US)

(21) Appl. No.: 15/464,958

(22) Filed: Mar. 21, 2017

Related U.S. Application Data
(60) Provisional application No. 62/312,776, filed on Mar. 24, 2016.

(51) Int. Cl. H04L 12/58; H04L 12/24

(52) U.S. Cl. CPC H04L 51/36; H04L 41/5019; H04L 41/5093; H04L 67/10

(57) ABSTRACT

A service defined network for hybrid unified communications receives high-level service requests for communication between geographic regions and/or enterprises. The service requests are processed by a resource provisioning system to provision uniform communication resources of the service defined network for fulfilling the service request. An order is issued to a network communication manager for reserving a specified network bandwidth for fulfilling the service request. The network communication manager allocates data flows for the specified network bandwidth between the regions and/or enterprises. QoS provisioning and monitoring are provided using a unified communications region-based service level API of the service defined network (not a SDN flow-level API).

### CROSS-REFERENCE TO RELATED APPLICATIONS

This patent application claims the benefit of U.S. Provisional Patent No. 62/312,776 filed Mar. 24, 2016. The content of U.S. Provisional Patent No. 62/312,776 is incorporated herein by reference.

### BACKGROUND

“Unified communication” (UC) services or unified communications and collaboration services (UCC) describe a cloud-based integration of real-time, enterprise-wide communication services (e.g., instant messaging, presence information, voice, mobility features, audio, web & video conferencing, fixed-mobile convergence, desktop sharing, data sharing, call control, and speech recognition) with non-real-time communication services (e.g., unified messaging, integrated voicemail, e-mail, SMS and fax). UC services are not necessarily provided by a single product or vendor, but typically by a set of products that provide a consistent unified user-interface and user-experience across multiple user devices and media-types. Thus, UC services can encompass all forms of communications that are exchanged via a network or multiple connected networks, whether directed as one-to-one communications or multicast/broadcast communications from one to many. In other words, UC services allow a user to send and receive the same type of communications on a variety of different media. For example, the user can receive a voicemail message and choose to access it through e-mail, a cell phone or another medium. Additionally, if the sender is online and currently accepts calls, a response to the voicemail can be sent immediately through yet another medium, such as text chat or video call. Otherwise, the response may be sent as a non-real-time message that can be accessed through a variety of media. These UC services are typically provided via a cloud-based system in order to enhance the ability to integrate, update, modify and manage the various types of communication services.

“Hybrid unified communication” (Hybrid UC) services incorporate on-premises services and cloud-based services for unified communications. Hybrid UC services thus enable enterprises to procure UC services through a variety of different deployment models, while supporting the seamless service integration often needed to deliver a UC experience to users. For example, hybrid UC services blend traditional on-premises, public cloud and private cloud deployment models. Hybrid UC services, therefore, allow enterprises to select different procurement models for different UC service functionality. Hybrid UC services can also support adoption of different procurement models for different user roles within the enterprise. However, a large, complex hybrid UC service system is difficult to implement, install, manage and maintain across multiple regions for many different enterprises.

### SUMMARY

The difficulties of implementing, installing, managing and maintaining a large, complex hybrid UC service system across multiple regions for many different enterprises are alleviated with a service defined network for hybrid unified communications that operates at a higher level than the software defined networks (SDNs) of the regions and enterprises to accelerate UC applications, improve backup times, and optimize bandwidth for integrated hybrid UC services. In some embodiments, high-level service requests for communication between the regions and/or enterprises (or the data centers or SDNs of the regions and/or enterprises) are processed by a resource provisioning system or unit (or a business operation support system and resource manager) to provision uniform communication resources of the service defined network for fulfilling the service request. An order is issued to a network communication manager (or WAN manager) for reserving a specified network bandwidth for fulfilling the service request. The network communication manager allocates data flows for the specified network bandwidth between the regions and/or enterprises (or between various network connectors of the regions and/or enterprises).

In some embodiments, a method includes receiving a request for communication services between two end-points of a hybrid unified communication (UC) network system; generating a request to provision UC resources within a UC service defined network controller for hybrid UC services, the request to provision UC resources being for fulfilling the request for communication services; provisioning UC resources within a database that maintains allocations of UC resources within the UC service defined network controller for hybrid UC services; generating an order to reserve network bandwidth for fulfilling the request for communication services; and allocating a data flow between end-point network connectors, the data flow fulfilling requirements of the request for communication services.

In some embodiments, a hybrid unified communication (UC) network system includes at least two end-point network connectors, a UC service defined network controller for hybrid UC services, a database, a business operation support system, a resource manager, and a WAN manager. The business operation support system, resource manager, and WAN manager are within the UC service defined network controller for hybrid UC services. The database maintains allocations of UC resources within the UC service defined network controller for hybrid UC services. The business operation support system is configured to 1) receive, from a service user entity, a UC service level request for communication services between the at least two end-points, and 2) generate a request to provision UC resources within the UC service defined network controller for hybrid UC services to fulfill the UC service level request for communication services. The resource manager is configured to 1) receive the request to provision UC resources, 2) provision the UC resources within the database, and 3) generate an order to reserve network bandwidth for fulfilling the UC service level request for communication services. The WAN manager is configured to 1) receive the order to reserve network bandwidth, and 2) allocate a data flow between the at least two end-point network connectors, the data flow fulfilling requirements of the UC service level request for communication services.

In some embodiments, a unified communications region-based service level API is included and configured to provide QoS provisioning and monitoring. In some embodiments, end-to-end QoS is reserved based on demand for unified communications services, management, and database synchronization purposes. In some embodiments, a user of the service defined network for hybrid unified communications pays only for UC services used by the user. In some embodiments, the network communication manager translates UC service level requests to software defined network flow-level configurations based on available UC services and a plurality of regional UC systems. In some embodiments, an analytics module is included and configured to collect operation and performance statistics for end-to-end UC services provided to customers and to map the statistics to a UC service level. In some embodiments, a status unit is included and configured to correlate status and event data from controllers for the first and second software defined networks to a status of the UC service level. In some embodiments, the resource provisioning unit and the network communication manager serve as an over-layered high-level transport network for integrated hybrid UC services in a multiple-cloud architecture among multiple geographic regions with multiple customers, multiple carriers, and multiple third party UC service systems. In some embodiments, the end-point network connectors comprise a WAN connector of the UC service defined network controller for hybrid UC services and a software defined network switch of a customer on-premises UC system. In some embodiments, the request for communication services is between both cloud-based and on-premises service user entities.

### BRIEF DESCRIPTION OF THE DRAWINGS

FIG. 1 is a simplified schematic diagram of an example hybrid unified communication network system incorporating an embodiment of the present invention.

FIG. 2 is a simplified schematic diagram of an example UC service defined network controller and on-premises UC system for use in the example communication network system shown in FIG. 1, in accordance with an embodiment of the present invention.

FIG. 3 is a simplified functional flow diagram for an example operation of some of the components of the example UC service defined network controller shown in FIG. 2, in accordance with an embodiment of the present invention.

FIG. 4 is an example format for a request to reserve resources within the example UC service defined network controller shown in FIG. 2, in accordance with an embodiment of the present invention.

FIG. 5 is another example format for a request to reserve resources within the example UC service defined network controller shown in FIG. 2, in accordance with an embodiment of the present invention.

### DETAILED DESCRIPTION

Reference now will be made in detail to embodiments of the disclosed invention, one or more examples of which are illustrated in the accompanying drawings. Each example is provided by way of explanation of the present technology, not as a limitation of the present technology. In fact, it will be apparent to those skilled in the art that modifications and variations can be made in the present technology without departing from the scope thereof. For instance, features illustrated or described as part of one embodiment may be used with another embodiment to yield a still further embodiment. Thus, it is intended that the present subject matter covers all such modifications and variations within the scope of the appended claims and their equivalents.

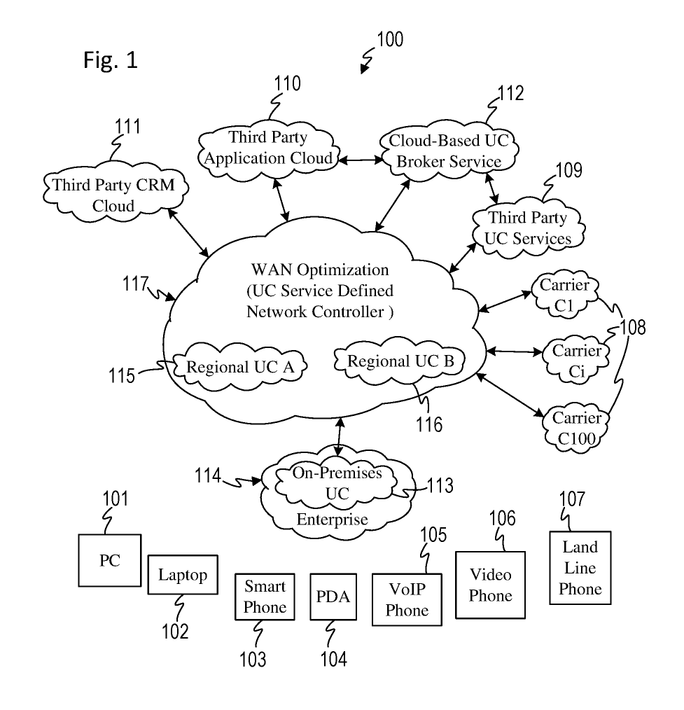

FIG. 1 shows an example hybrid unified communication network system 100, in accordance with some embodiments, with which end users communicate with each other using a variety of end-point communication devices (e.g., personal computers (PC) 101, laptop computers 102, smartphones 103, personal digital assistants (PDA) 104, voice over Internet protocol (VoIP) phones 105, video phones 106, land line phones 107, smart watches, smart cars, etc.). The end-point communication devices 101-107 generally transmit and receive communication data through a variety of paths or communication access systems, e.g., a variety of carriers 108 for telephone services, third party UC service systems 109, third party application cloud systems 110, third party customer relationship management (CRM) cloud systems 111, cloud-based UC broker service systems 112 (e.g., to facilitate integration of different communication services), and customer on-premises UC systems 113 of various enterprises 114, among other potential systems. The communication access systems 108-113 generally communicate through multiple geographic regional UC systems, e.g., regional UC A 115 and regional UC B 116, of a UC “service defined network” controller, or wide area network (WAN) optimization system 117, for hybrid UC services. The WAN optimization system 117 enables UC as a service (UCaaS) functionality for quality of service (QoS) provisioning and communication management between data centers having software defined networks (SDNs) for the multiple regional UCs 115 and 116 and the on-premises UC systems 113 having SDNs.

The WAN optimization system 117 is, thus, a hybrid UC service system that incorporates UC services deployed across multiple different clouds, yet supports a proper network QoS over the Internet. Additionally, service-level agreements (SLA) for the UC services in this situation can be guaranteed. Furthermore, since many UC services use a SDN for (low-level) “flow-level” control and management of communications, the WAN optimization system 117 enables the UC services to be provided across multiple geographic regional systems with convenient provisioning and control of the communications at the flow-level for each of the many end users of the UC services within the multiple geographical regions. Additionally, although some network elements that may be used within the regional systems might not support SDN, the WAN optimization system 117 further enables easy integration of these network elements with other network elements that operate with SDNs. The WAN optimization system 117 can, therefore, implement, install, manage and maintain a large, complex hybrid UC service system across multiple regions for many different enterprises.

In accordance with the description herein, the various illustrated components of the communication network system 100 generally represent appropriate hardware and software components for providing the described resources and performing the described functions. The hardware generally includes any appropriate number and combination of computing devices, network communication devices, and peripheral components connected together, including various processors, computer memory (including transitory and non-transitory media), input/output devices, user interface devices, communication adapters, communication channels, etc. The software generally includes any appropriate number and combination of conventional and specially-developed software with computer-readable instructions stored by the computer memory in non-transitory computer readable media and executed by the various processors to perform the functions described herein.

The WAN optimization system 117 manages the regional UCs 115 and 116 through secure channels (e.g., virtual private networks (VPN)) and provides integration with, and APIs for, the third party UC service systems 109, the third party application cloud systems 110, the third party CRM cloud systems 111, and the cloud-based UC broker service systems 112. The WAN optimization system 117, thus, operates at a level that is higher than, or above, the SDN controllers and other network management protocols, e.g. Network Configuration Protocol (Netconf) and command line interface (CLI), of the regional UCs 115 and 116 and the on-premises UC systems 113. In this configuration, the WAN optimization system 117 provides a benefit of accelerating UC applications, improving backup times, and optimizing bandwidth for integrated hybrid UC services for the enterprises 114 and their individual users. QoS provisioning and monitoring are provided by a unified communications region-based service level application program interface (API) of the WAN optimization system 117, e.g., a representational state transfer (REST) API, rather than by a flow-level API of the SDNs. The end-to-end QoS provisioning is reserved based on demand for UC services, system management, and database synchronization purposes. Additionally, with this configuration, the UC services can be managed in such a manner that a user or customer pays only for the UC services that are used by that user or customer. Furthermore, in some embodiments, both active-active and active-standby modes are supported with geographical redundancy and disaster recovery (GR/DR) support.

The WAN optimization system 117 generally translates UC service level or layer requests to SDN flow-level configurations, Netconf configurations, or CLI configurations based on information regarding the available UC services and the various regional UCs 115 and 116. The WAN optimization system 117 (e.g., by an analytics module) is also configured to collect operation and performance statistics from the various network elements and components for each end-to-end UC service provided to customers and to map the results to the UC service level. The WAN optimization system 117 also correlates status and event data from the various SDN controllers and other management protocols to the status of the UC service level. Additionally, the WAN optimization system 117 provides a web-based North Bound Interface (NBI) function to a UC resource manager for service integration.

The WAN optimization system 117, thus, serves as an over-layered high-level transport network for integrated hybrid UC services in a multiple-cloud architecture among multiple countries and/or geographic regions (e.g., for the geographic regional UCs 115/116) with multiple enterprises 114 (e.g. tenants and/or customers), multiple carriers 108, and multiple third party UC service systems 109. Also, the WAN optimization system 117 coordinates and manages cloud-based UC services, customer on-premises UC services, and hybrid (cloud and on-premises) UC services in each country or region (e.g., for the regional UCs 115/116). Additionally, the WAN optimization system 117 can handle communication traffic for any of the end-point communication devices 101-107. Furthermore, the WAN optimization system 117 provides easy integration with the third party CRM cloud systems 111 and APIs (e.g., through API gateways) for the third party application cloud systems 110.

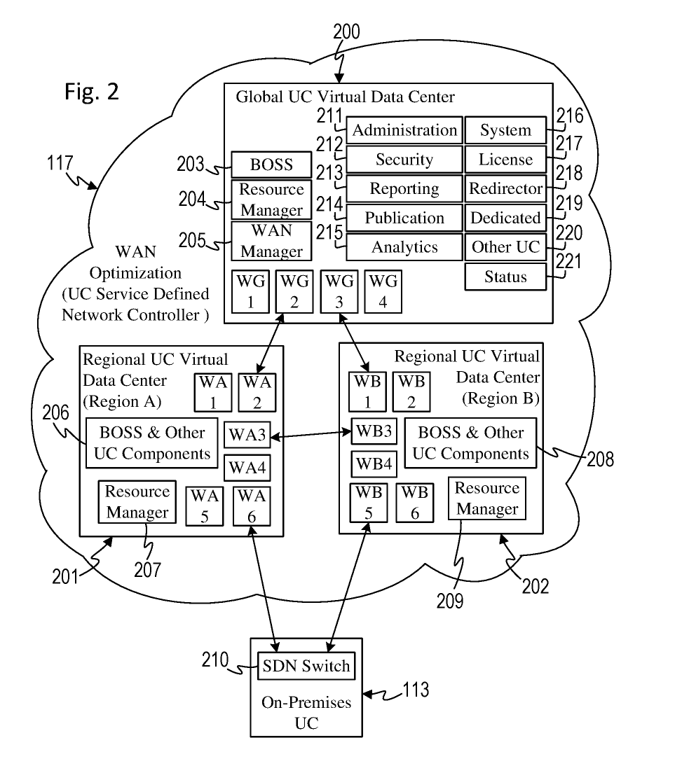

In some embodiments, as shown in FIG. 2, the UC service defined network controller for hybrid UC services (the WAN optimization system 117) generally includes a global UC virtual data center 200 and any number of regional UC virtual data centers 201 (for the regional UC A 115) and 202 (for the regional UC B 116). The global UC virtual data center 200 generally includes a business operation support system (BOSS) 203, a resource manager 204, a WAN manager (or network communication manager) 205, and several WAN (or network) connectors WG1-4. The regional UC virtual data center 201 generally includes a BOSS (and other UC components, e.g., contact center, PBX, messaging service, analytics, etc.) 206, a resource manager 207, and several WAN (or network) connectors WA1-6. Similarly, the regional UC virtual data center 202 generally includes a BOSS (and other UC components, e.g., contact center, PBX, messaging service, analytics, etc.) 208, a resource manager 209, and several WAN (or network) connectors WB1-6. Additionally, the customer on-premises UC systems 113 generally include an SDN switch 210 as an on-premises end-point network connector.

The BOSS 203 of the global UC virtual data center 200 is generally an operation and management platform for providing comprehensive business support and services for telecom data processing operations, e.g., for service request conversion and handling, resource provisioning, product management, channel management, resource management, service activation, partner management, billing, collection, accounting and/or other functions for simultaneous real-time processing of a large data volume for many users. The BOSS 206 or 208 of the regional UC virtual data center 201 or 202 provides similar services on a regional basis, as well as other UC components and functions, e.g., contact center, PBX, messaging service, analytics, etc.

The resource manager 204 of the global UC virtual data center 200 handles service requests for provisioning resources between the various regional UC systems 115 and 116 at the UC service level (i.e., virtualized high level of the WAN optimization system 117) by dynamically adjusting the high level virtual network to the changing needs of the underlying lower level SDNs of the various regional UC systems 115 and 116 and of the global UC virtual data center 200 itself. The resource manager 207 or 209 of the regional UC virtual data center 201 or 202 provides similar services on the regional level for the SDN level communication connections between other regional UC virtual data centers and the various on-premises UC systems 113.

The WAN manager 205 converts the high level service requests (for reserving network resources received or generated at the level of the global UC virtual data center 200) to the lower software defined network flow-level for allocating transport flows for end-point network connectors between the various regional UC virtual data centers 201 and 202 and of the global UC virtual data center 200 itself. The allocation of flows is generally performed in accordance with an appropriate protocol for runtime data traffic to establish a data “pipe” from a QoS point of view. For example, in some embodiments, the WAN manager 205 performs these functions according to the OpenFlow™ standard of the Open Networking Foundation for establishing communication interfaces between control and forwarding layers of the architecture to enable direct access to and manipulation of the forwarding plane of various network devices, such as switches and routers, both physical and virtual. The establishment of the flows also ensures that if one of the regional UC virtual data centers 201 or 202 goes down, the other data center can immediately take over handling the UC services.

The WAN connectors WG1-4, WA1-6 and WB1-6 represent physical and virtual (software in the cloud) network components for end-point network connectors that perform the real-time data transport or communication functions between service user entities, or end-points. The actual data traffic between the SDNs of the various regional UC virtual data centers 201 and 202 and the global UC virtual data center 200 passes through the WAN connectors WG1-4, WA1-6 and WB1-6. In some embodiments, the WAN connectors WG1-4, WA1-6 and WB1-6 are provided in redundant groups or pairs (e.g., pairs WG1/2, WG3/4, WA1/2, WA3/4, WA5/6, WB1/2, WB3/4, WB5/6). Thus, if one WAN connector of a pair stops functioning (i.e., goes down or is turned off), then the other WAN connector of the pair can take over the data transport function between the same data centers 200, 201 and 202.

The on-premises SDN switch 210 provides redundant wireline paths to the WAN optimization system 117. Thus, the SDN switch 210 generally represents any appropriate hardware components physically deployed at the premises of the enterprises 114 for connecting, or forming a bridge between, the regional UC virtual data center 201 or 202 and various on-premises network or communication devices. The on-premises network devices generally include various components (e.g., VoIP switches, voice PBX switches, WiFi routers/repeaters, Ethernet hubs, phones, computers, etc.) for communication or data transport networks, such as Internet protocol (IP) networks, etc. The SDN switch 210, thus, provides a gateway for the enterprises 114 to the WAN optimization system 117, various cloud systems, the World Wide Web, and the Internet.

Furthermore, the data centers 200, 201 and 202 and the on-premises UC systems 113 may also have other elements. For example, the global UC virtual data center 200 may have an administration unit 211 for access by a system administrator, a security subsystem 212 for ensuring against intrusions and other security violations, a reporting unit 213 for generating status and performance reports, a service and application publication subsystem 214 for maintaining relevant publications, an analytics module 215 for generating statistics and analyzing data, a system manager 216 for performing system oversight functions, a license manager 217 for maintaining relevant license permissions for Enterprise Cloud/Partner-Managed Cloud agreements, a redirector unit 218 for redirecting communication traffic when needed, dedicated service computing clusters 219 (e.g., for VoIP, video calls, conference calls, etc.), other UC service computing clusters 220 (e.g., for instant messaging, voice mail, etc.) and/or a status unit 221 for correlating status and event data from the various SDN controllers and other management protocols to the status of the UC service level. The regional UC virtual data centers 201 and 202 may have similar elements. Additionally, the on-premises UC systems 113 may have various network or communication devices (mentioned above) for communicating between the SDN switch 210 and various end-point communication devices (e.g., 101-107) that are on-premises. The data centers 200, 201 and 202 and the on-premises UC systems 113 may also have other elements not shown for simplicity. Therefore, the particular elements shown and/or described are provided for illustrative purposes only for some embodiments. Other embodiments may have other specific elements and/or combinations of elements.

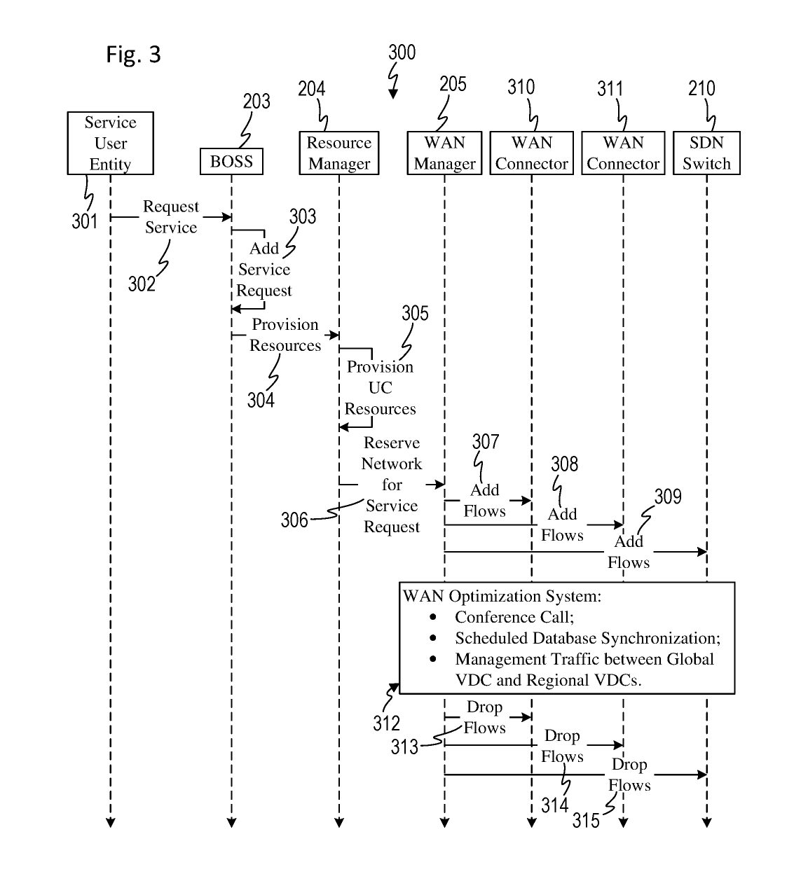

FIG. 3 shows a simplified functional flow diagram 300 for an example operation which the BOSS 203, the resource manager 204, the WAN manager 205, and the WAN connectors WG1-4 of the UC service defined network controller or WAN optimization system 117 are configured to perform as the over-layered high-level transport network for integrated hybrid UC services, in accordance with an embodiment of the present invention for various user cases. The particular functions shown in the flow diagram 300 are for illustrative and descriptive purposes only for some embodiments. Other embodiments can use other specific functions or combinations of functions.

In the illustrated example, a service user entity 301 (e.g., a subscriber, an individual user, a customer, an enterprise, a data center, a UC system management module, etc.) generates a service request (at 302) for communication services (e.g., a conference call, a dedicated data transport allocation, a temporary bandwidth allocation, or other user case or desired communication) with another service user entity, or between two end-points. The service request is provided to the BOSS 203.

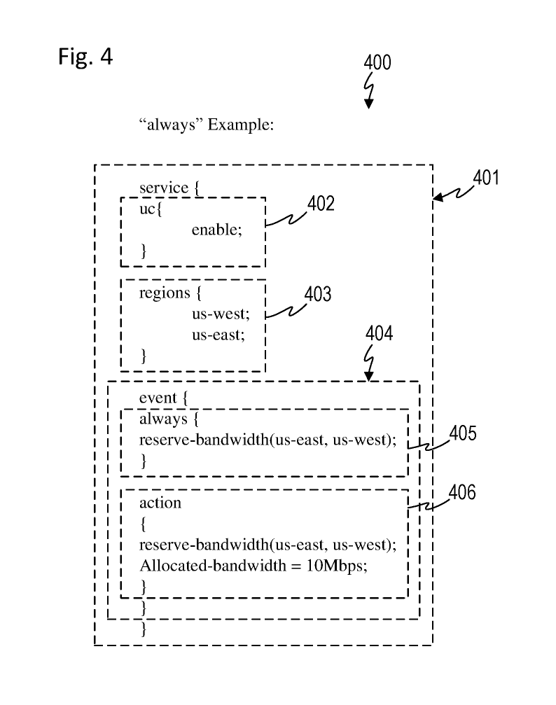

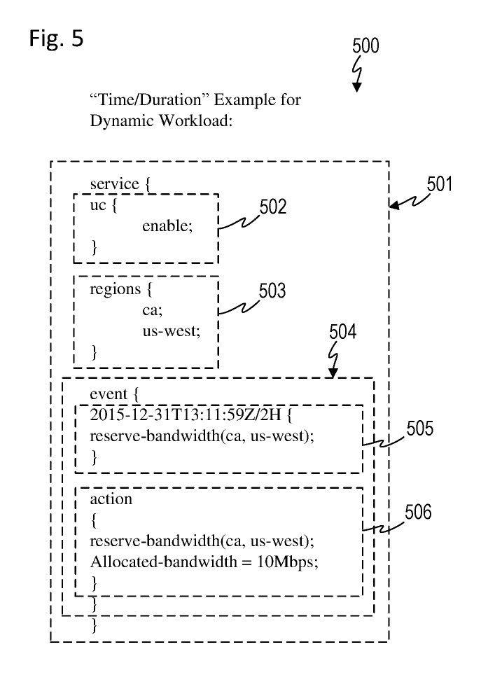

In response to receiving the service request, the BOSS 203 adds (at 303) the service request to a list of all service requests and issues (at 304) to the resource manager 204 a request to provision UC resources within the WAN optimization system 117 based on the service request and for fulfilling the service request. The resource manager 204 receives the request to provision UC resources and provisions (at 305) the UC resources within a database that maintains or keeps track of the provisioning or allocating of all UC resources within the WAN optimization system 117. The resource manager 204 generates an order to reserve network bandwidth for fulfilling the service request and issues (at 306) the order to the WAN manager 205. The resource manager 204 coordinates the eventual flow allocation with a call to a North Bound Interface (NBI) of the WAN manager 205. Example formats for the NBI calls are shown in FIGS. 4 and 5 below for two example cases. In some embodiments, these functions of the BOSS 203 and the resource manager 204 are treated together as a combined resource “provisioning” system or unit.

In response to receiving the order to reserve network bandwidth for fulfilling the service request, the WAN manager 205 adds, generates, allocates or reserves the actual data flows (at 307, 308 and 309) between service user entities, or end-point network connectors, e.g., various WAN connectors (e.g., 310 and 311, similar to WG1-4, WA1-6 and WB1-6) and SDN switches (e.g., 210) that are needed to fulfill the requirements of the order or service request. The allocation of the flows is a translation from the high-level service request to low-level flow-level commands, i.e., a translation from UC service level or layer requests to SDN flow-level configurations, Netconf configurations, or CLI configurations based on information regarding the available UC services and the various regional UCs 115 and 116. The flow added for the SDN switch 210 is needed only if the service request is between both cloud-based and on-premises service user entities, rather than between only cloud-based service user entities. The QoS provisioning for the order is reserved based on current or anticipated network usage demand using the NBI calls of the WAN manager 205, rather than the low-level flow-based API in the SDN Controller of the SDN switch (e.g., 210), Netconf, or CLI of the regional UC virtual data centers 201 or 202. In this manner, the QoS will be provided end-to-end for the requested UC services and the service user entity will pay only for the UC resources that are used for the requested UC services, i.e., to fulfill the request for communication services.

Once the data flows have been allocated, the desired communication can proceed (at 312) through the WAN optimization system 117. For example, in the illustrated user cases, if the service request was for a conference call between two or more users, a scheduled database synchronization within the global UC virtual data center 200, or management traffic between the global UC virtual data center (Global VDC) 200 and one or more of the regional UC virtual data centers (Regional VDCs) 201 or 202, then the conference call, the database synchronization, or the management traffic can proceed (at 312) through the WAN optimization system 117.

After the desired communication (for the received service request) through the WAN optimization system 117 has completed, the WAN manager 205 drops or deallocates (at 313, 314 and 315) the various flows, depending on the type of user case. For example, if the service request was for a conference call, and the conference call has been completed, then the flows are no longer needed, so the flows can be dropped. On the other hand, if the service request was for a long-term or persistent usage, such as a dedicated call center or internal system management traffic, then the flows are not dropped, but are maintained indefinitely.

FIGS. 4 and 5 show example NBI call formats 400 and 500 for the order to reserve network bandwidth issued (at 306) to the WAN manager 205, in accordance with an embodiment of the present invention. The particular formats shown are for illustrative and descriptive purposes only for some embodiments. Other embodiments may use other formats.

The example NBI call format 400 shown in FIG. 4 is for a user case in which it is desired to establish a data flow that remains in operation indefinitely or until specifically deallocated, i.e., an “always” case. The example NBI call format 500 shown in FIG. 5, on the other hand, is for a user case in which it is desired to establish a data flow at a particular time for a particular time duration, i.e., a “time/duration” case. In each case, the particular network service 401 and 501 is defined. Unified communication is enabled in 402 and 502 for both user cases. The UC regional data centers to be connected are specified in 403 and 503 (e.g., a data center “us-west” for the Western United States and a data center “us-east” for the Eastern United States in FIG. 4, and a data center “ca” for Canada and the data center “us-west” in FIG. 5).

The particular event is specified in 404 and 504. In FIG. 4, the event is an “always” on connection that reserves bandwidth between the data centers “us-west” and “us-east” (“always {reserve-bandwidth(us-east, us-west);}”) as specified in 405. In FIG. 5, the event is a connection that starts on a particular day (“2015-12-31”=Dec. 31, 2015) at a particular time (“T13:11:59Z”=1:11 PM Universal Time) for a particular time period (“2H”=two hours) and reserves bandwidth between the data centers “ca” and “us-west” (“2015-12-31T13:11:59Z/2H {reserve-bandwidth(ca, us-west);}”) as specified in 505. In 406 and 506, the particular action for the event is specified as allocating a bandwidth of 10 Mbps between the specified data centers. The WAN manager 205 uses the data in these NBI calls to establish the actual data flows between WAN connectors for these data centers.

One or more aspects or features of the subject matter described herein can be realized in digital electronic circuitry, integrated circuitry, specially designed application specific integrated circuits (ASICs), field programmable gate arrays (FPGAs), computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or an assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a machine-readable medium. The machine-readable medium can store such machine instructions non-transitorily, such as for example as would a non-transient solid-state memory or a magnetic hard drive or any similar storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor, for displaying information to the user and a keyboard and a pointing device, such as for example a mouse, a touchpad or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one” or “one or more” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the scope of the present invention, which is more particularly set forth in the appended claims. Furthermore, those of ordinary skill in the art will appreciate that the foregoing description is by way of example only, and is not intended to limit the invention.

What is claimed is:

1. A service defined network for hybrid unified communications (UCs) comprising:
first and second network connectors for first and second software defined networks;
a resource provisioning unit configured to receive a service request for communication between the first and second software defined networks, to provision uniform communication resources of the service defined network for fulfilling the service request, and to issue an order to reserve a specified network bandwidth for fulfilling the service request; and
a network communication manager in communication with the resource provisioning unit and the first and second network connectors, and configured to receive the order to reserve the specified network bandwidth and to allocate data flows for the specified network bandwidth between the first and second network connectors.

2. The service defined network for hybrid unified communications of claim 1, further comprising:
a unified communications region-based service level API configured to provide QoS provisioning and monitoring.

3. The service defined network for hybrid unified communications of claim 1, wherein:
end-to-end QoS is reserved based on demand for unified communications services, management, and database synchronization purposes.

4. The service defined network for hybrid unified communications of claim 1, wherein:
a user of the service defined network for hybrid unified communications pays only for UC services used by the user.

5. The service defined network for hybrid unified communications of claim 1, wherein:
the network communication manager translates UC service level requests to software defined network flow-level configurations based on available UC services and a plurality of regional UC systems.

6. The service defined network for hybrid unified communications of claim 5, further comprising:
an analytics module configured to collect operation and performance statistics for end-to-end UC services provided to customers and to map the statistics to a UC service level.

7. The service defined network for hybrid unified communications of claim 6, further comprising:
a status unit configured to correlate status and event data from controllers for the first and second software defined networks to a status of the UC service level.

8. The service defined network for hybrid unified communications of claim 1, wherein:
the resource provisioning unit and the network communication manager serve as an over-layered high-level transport network for integrated hybrid UC services in a multiple-cloud architecture among multiple geographic regions with multiple customers, multiple carriers, and multiple third party UC service systems.

9. The service defined network for hybrid unified communications of claim 8, wherein:
the resource provisioning unit and the network communication manager coordinate and manage cloud-based UC services, customer on-premises UC services, and hybrid cloud/on-premises UC services in the geographic regions.

10. A method comprising:
receiving, by a business operation support system from a service user entity, a request for communication services between two end-points of a hybrid unified communication (UC) network system;
generating, by the business operation support system, a request to provision UC resources within a UC service defined network controller for hybrid UC services, the request to provision UC resources being for fulfilling the request for communication services;
receiving, by a resource manager from the business operation support system, the request to provision UC resources;
provisioning, by the resource manager, UC resources within a database that maintains allocations of UC resources within the UC service defined network controller for hybrid UC services;
generating, by the resource manager, an order to reserve network bandwidth for fulfilling the request for communication services;
receiving, by a WAN manager, the order to reserve network bandwidth; and
allocating, by the WAN manager in response to the order to reserve network bandwidth, a data flow between end-point network connectors, the data flow fulfilling requirements of the request for communication services.

11. The method of claim 10, wherein:
the end-point network connectors comprise a WAN connector of the UC service defined network controller for hybrid UC services and a software defined network switch of a customer on-premises UC system.

12. The method of claim 11, wherein:
the request for communication services is between both cloud-based and on-premises service user entities.

13. The method of claim 11, further comprising:
reserving, by the WAN manager, QoS provisioning for the order to reserve network bandwidth based on current or anticipated network usage demand using a north bound interface call of the WAN manager, not a flow-based API in the software defined network switch.

14. The method of claim 13, wherein:
the service user entity pays only for the UC resources that are used to fulfill the request for communication services.

15. The method of claim 10, wherein:
the allocation of the data flow is a translation from a higher level of the request for communication services to a lower level of flow-level commands.

16. The method of claim 15, wherein:
the translation is based on available UC services and a plurality of regional UC systems.

17. A hybrid unified communication (UC) network system comprising:
at least two end-point network connectors;
a UC service defined network controller for hybrid UC services;
a database that maintains allocations of UC resources within the UC service defined network controller for hybrid UC services;
a business operation support system within the UC service defined network controller for hybrid UC services;
a resource manager within the UC service defined network controller for hybrid UC services and connected to the business operation support system; and
a WAN manager within the UC service defined network controller for hybrid UC services and connected to the business operation support system and the resource manager;
wherein:
the business operation support system is configured to 1) receive, from a service user entity, a UC service level request for communication services between the at least two end-points, and 2) generate a request to provision UC resources within the UC service defined network controller for hybrid UC services to fulfill the UC service level request for communication services;
the resource manager is configured to 1) receive the request to provision UC resources, 2) provision the UC resources within the database, and 3) generate an order to reserve network bandwidth for fulfilling the UC service level request for communication services; and
the WAN manager is configured to 1) receive the order to reserve network bandwidth, and 2) allocate a data flow between the at least two end-point network connectors, the data flow fulfilling requirements of the UC service level request for communication services.

18. The hybrid UC network system of claim 17, further comprising:
a unified communications region-based service level API configured to provide QoS provisioning and monitoring, wherein end-to-end QoS is reserved based on demand for unified communications services, management, and database synchronization purposes.

19. The hybrid UC network system of claim 17, wherein:
the WAN manager translates UC service level requests to software defined network flow-level configurations based on available UC services and a plurality of regional UC systems.

20. The hybrid UC network system of claim 17, wherein:
the business operation support system, the resource manager, and the WAN manager serve as an over-layered high-level transport network for integrated hybrid UC services in a multiple-cloud architecture among multiple geographic regions with multiple customers, multiple carriers, and multiple third party UC service systems.
